(19) United States
(12) Patent Application Publication
(10) Pub. No.: US 2011/0132492 A1
(43) Pub. Date: Jun. 9, 2011

(54) DEVICE FOR PREPARING AN AQUEOUS SOLUTION OF SALT, PARTICULARLY OF CALCIUM CHLORIDE, FOR USE AS A SURFACE DEICER....

(76) Inventors: Silvano Marin, Bolzano (IT); Andrea Marin, Bolzano (IT)

(21) Appl. No.: 12/737,675

(22) PCT Filed: Aug. 7, 2009
(86) PCT No.: PCT/EP2009/060308

§ 371 Date: Feb. 4, 2011

(30) Foreign Application Priority Data
Aug. 11, 2008 (IT) VR2008A000088
Dec. 30, 2008 (IT) VR2008A000143
Mar. 9, 2009 (IT) VR2009A000022

(51) Int. Cl. B65B 3/04; B01F 3/12

(52) U.S. Cl. 141/98; 366/341

(57) ABSTRACT

A device for preparing an aqueous solution of calcium chloride, particularly for use as a surface deicer, comprising a containment tank which defines a body for containing the water in which the calcium chloride in solid form is to be dissolved and at least one fill opening for the calcium chloride in solid form, elements for mixing the water with the calcium chloride in solid form in order to obtain a solution of water and calcium chloride; the mixing elements comprise means for the forced circulation of the fluid contained in the containment body within the containment tank. It is also disclosed a device for distributing an aqueous solution for use as a surface deicer comprising a plurality of straight jet nozzles designed to direct, toward the surface onto which said aqueous solution is to be spread, a respective jet designed to strike a substantially point-like region of the ground.

The present invention relates to a device for preparing an aqueous solution of salt, particularly of calcium chloride, for use as a surface deicer.

### BACKGROUND OF THE INVENTION

It is known to use solutions of water and calcium chloride as surface deicers on roads, since this solution has an extremely low freezing point (approximately −51° C.) at a 30% concentration.

It can be used both by spraying on roads and viaducts and as a humidifying solution to be added, during spreading, to salt and/or sand.

Generally, the solution of water and calcium chloride is obtained by mixing the two components with mechanical blades or with simple systems for recirculation or percolation inside mixing tanks and is subsequently transferred to storage tanks.

The transport vehicles (trucks and corresponding tank for the solution) are then placed proximate to the storage tank so as to allow the mixed solution to be transferred through an appropriately provided pump into the tank of the truck.

It has been found that in currently operating plants the solubilization times are particularly long and this in practice prevents the exploitation of a typical property of the solution of water and calcium chloride, which consists in an exothermic reaction generated during the dissolution of calcium chloride in water: in practice, at the end of the solubilization process (with a 26% concentration) one obtains a significant increase in the temperature of the solution to approximately 48° C.

In practice, due to the times—which, as mentioned, are long—needed to ensure correct solubilization and due to the fact that the trucks onto which the solution is loaded require a certain time to reach the area where such solution is to be used, the solution is used when its temperature has already dropped drastically, with the obvious result of not being able to exploit fully all its deicer properties.

### SUMMARY OF THE INVENTION

The aim of the present invention is to provide a device for preparing an aqueous solution of salt, particularly calcium chloride, for use as a surface deicer, which is capable of overcoming or at least reducing drastically the limitations described above.

Within this aim, an object of the present invention is to provide a device for preparing an aqueous solution of salt, particularly calcium chloride, for use as a surface deicer that makes it possible to use the solution in short time, so as to make it possible to also exploit the thermal characteristics of the solution to the full extent.

This is particularly important in those critical points (for example bridges and viaducts) where frost, due to higher exposure to air currents, the higher relative humidity due to the presence of watercourses and the lower thermal inertia that is typical of such works of art, occurs more rapidly, often causing veritable emergencies.

Another object of the invention is to propose a device for preparing an aqueous solution of salt, particularly calcium chloride, for use as a surface deicer, which has a competitive production and management cost, so as to make its use advantageous also from the economic point of view.

This aim, as well as these and other objects that will become better apparent hereinafter, are achieved by a device for preparing an aqueous solution of salt, particularly calcium chloride, for use as a surface deicer according to claim 1.

### BRIEF DESCRIPTION OF THE DRAWINGS

Further characteristics and advantages of the invention will become better apparent from the following detailed description of some preferred but not exclusive embodiments of a device for preparing an aqueous solution of calcium chloride, particularly for use as a surface deicer, according to the invention, illustrated by way of non-limiting examples in the accompanying drawings, wherein:

FIG. 1 is a schematic lateral elevation view of a silo for containing the calcium chloride in solid form, below which a truck that has a containment tank as its trailer is arranged;

FIG. 2 is a rear elevation view of the silo associated with the truck shown in FIG. 1;

FIG. 3 is an enlarged-scale view of the truck shown in FIG. 2, in which the trailer, for the sake of clarity, is shown in partial cross-section;

FIG. 4 is a longitudinal sectional view of a containment tank;

FIG. 5 is a top view of the containment tank, in which part of the filter has been omitted for the sake of greater clarity;

FIG. 6 is a perspective view of a truck which has a containment tank as its trailer;

FIG. 7 is a view of another embodiment of the containment tank, taken along a longitudinal cross-section;

FIG. 8 is a transverse sectional view of the embodiment of the containment tank shown in FIG. 7;

FIG. 9 is a top plan view of the embodiment of the containment tank shown in FIGS. 7 and 8;

FIG. 10 is a sectional view of a fixed containment tank according to the invention;

FIG. 11 is a top view of the fixed containment tank shown in FIG. 10, in which the top closure cover has been omitted for the sake of greater clarity;

FIG. 12 is a schematic perspective view of the device for distributing on the roads an aqueous solution for use as a surface deicer;

FIG. 13 is another perspective view of a practical application of the distribution device on a truck with a tank;

FIG. 14 is a sectional view of the roadway affected by the action of the distribution device;

FIG. 15 is a longitudinal sectional view of the containment tank.

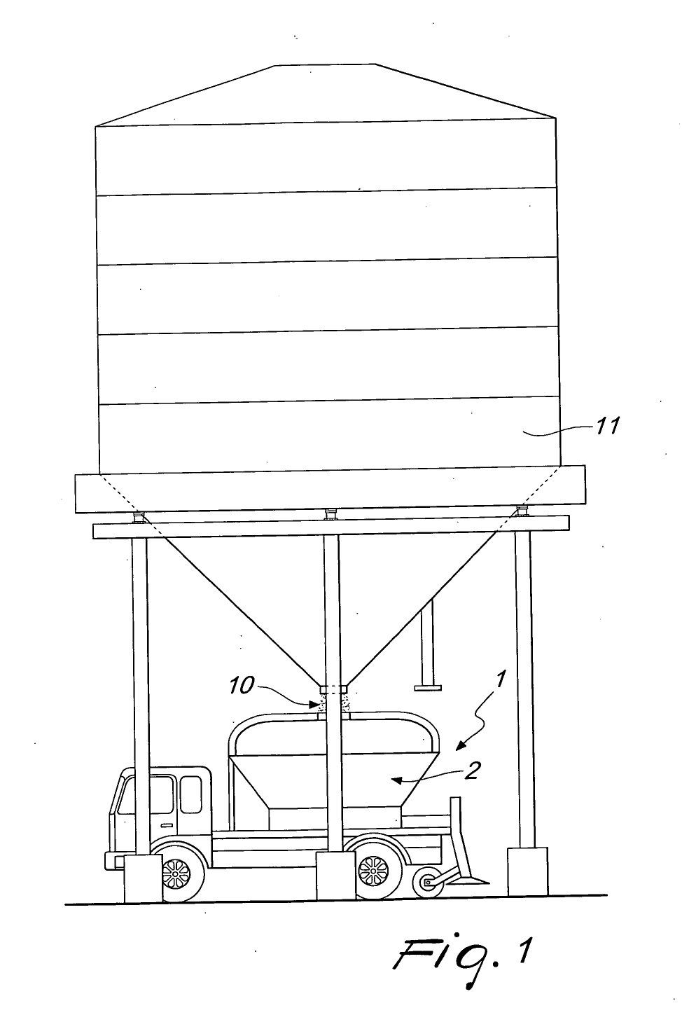

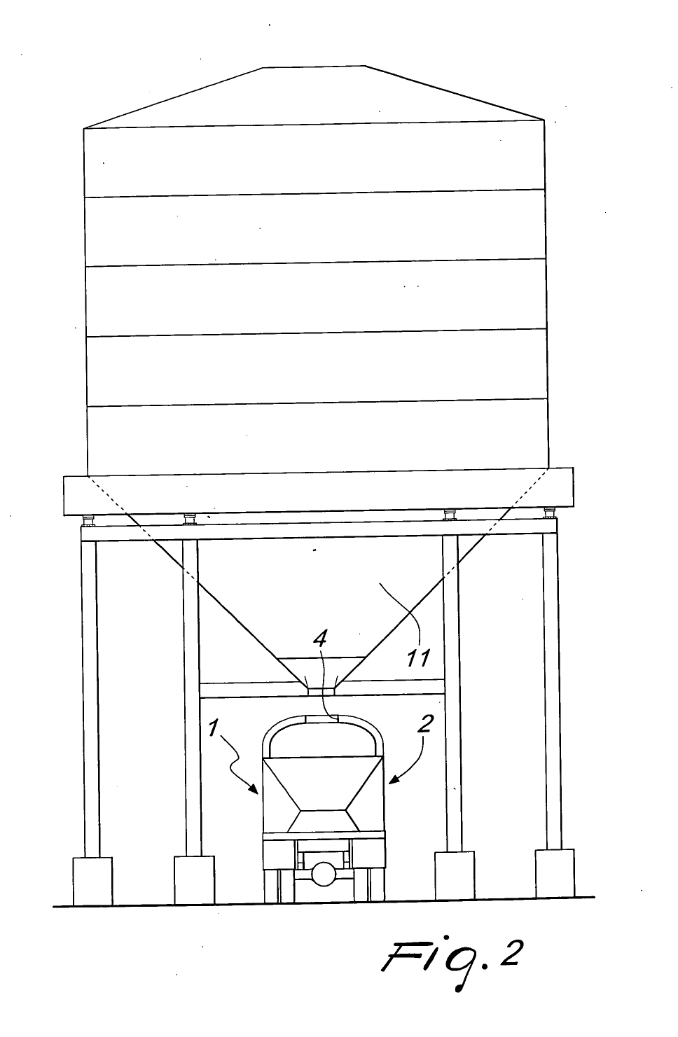

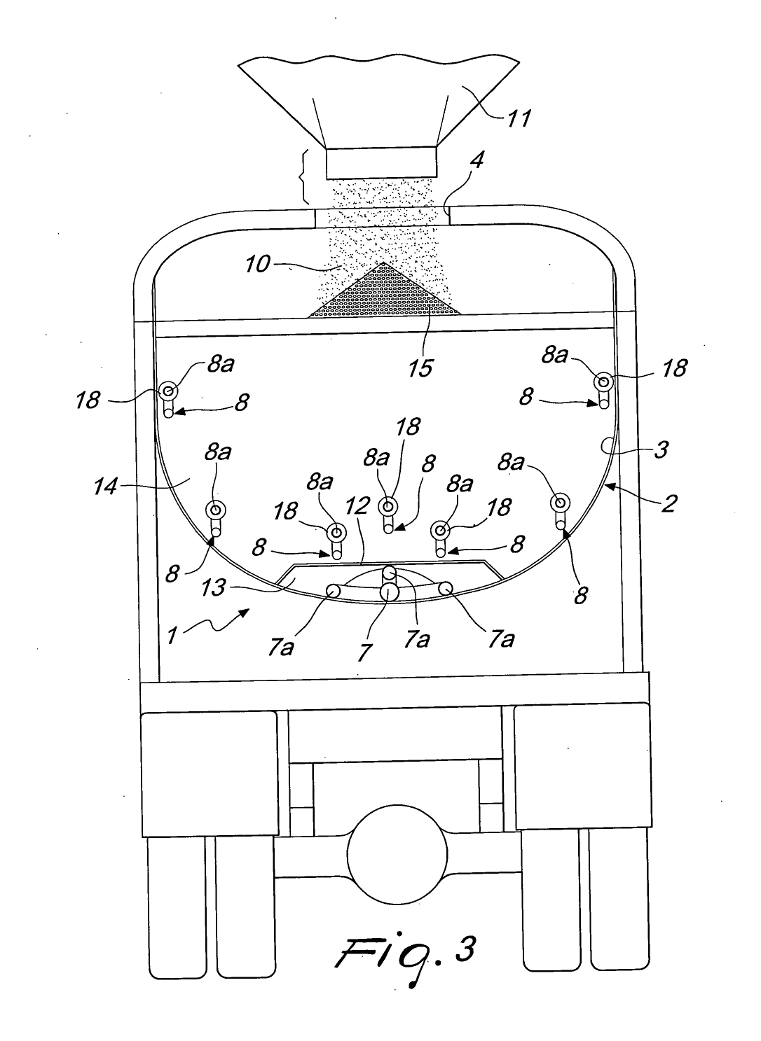

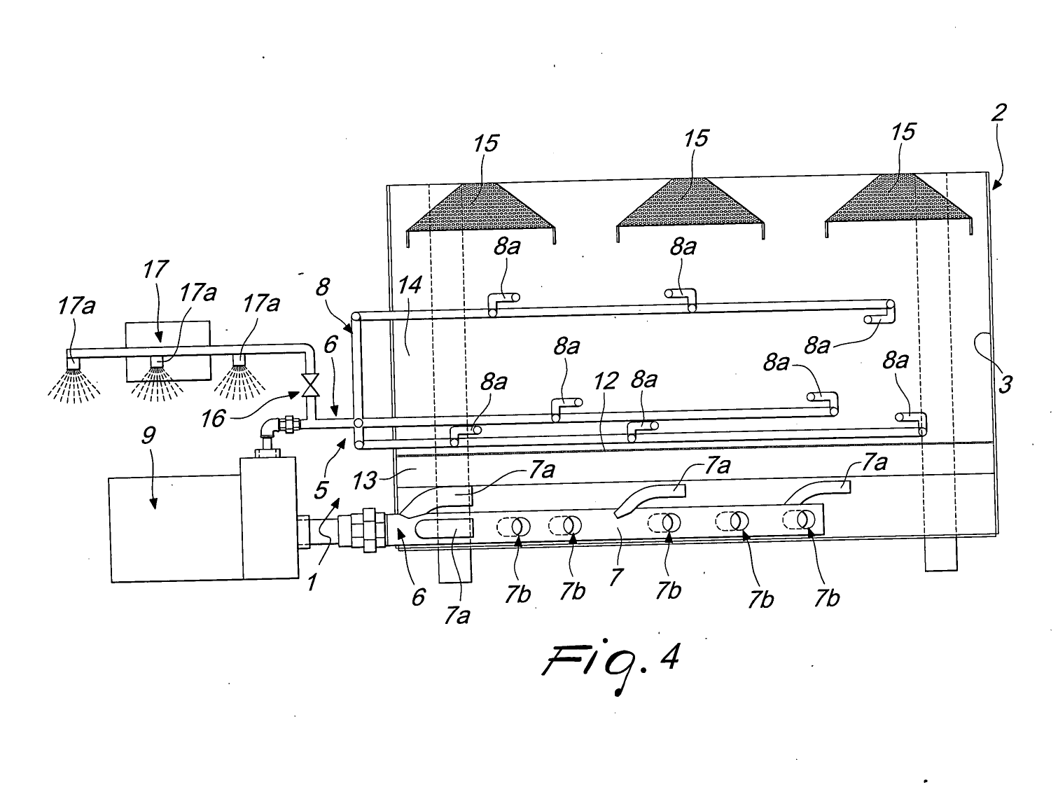

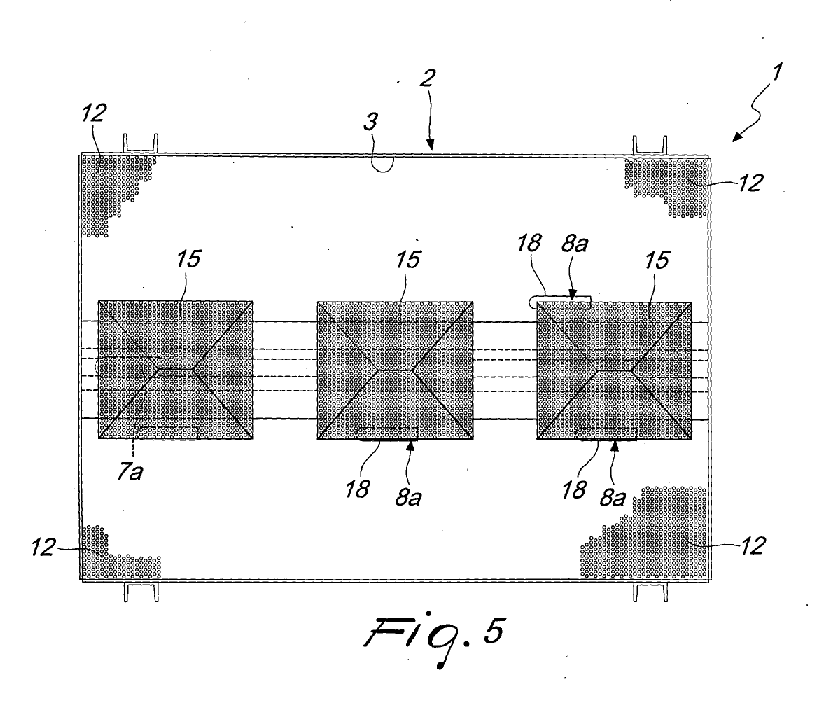

### DESCRIPTION OF THE PREFERRED EMBODIMENTS

In the exemplary embodiments that follow, individual characteristics, given in relation to specific examples, may actually be replaced by other different characteristics that exist in other exemplary embodiments.

Moreover, it is noted that anything found to be already known during the patenting process is understood not to be claimed and to be the subject of a disclaimer.

With reference to the figures, a preferred embodiment is described of a device for preparing an aqueous solution of salt, particularly of calcium chloride, generally designated by the reference numeral 1, for use as a surface deicer.

In the description that follows, reference shall be made to calcium chloride, but of course nothing forbids to use the device 1 to solubilize other products, such as, merely by way of example, sodium chloride or urea.

The device 1 comprises in particular a containment tank 2 which forms internally a body 3 for containing the water in which the calcium chloride in solid form 10 is to be dissolved (typically in the form of flakes).

In the outer wall of the containment tank 2 there is further provided at least one fill opening 4 for the calcium chloride in solid form 10, which is generally stored within silos 11.

Nothing forbids, of course, envisaging that the calcium chloride in solid form 10 can be loaded even manually, for example by means of bags or sacks.

Advantageously, the fill opening or openings 4 is or are provided at the top portion of the containment tank 2, so as to allow the unloading of the salt 10 by gravity into the containment body 3.

The device 1 has means for mixing the water contained inside the containment body 3 with the calcium chloride in solid form 10 in order to obtain rapidly a solution of water and calcium chloride that can be used to be for example spread while still warm on roads and viaducts in case of frost or snow or to moisten the solid salt or sand to be spread on the roads for the same purpose.

According to the present invention, the mixing means comprise means 5 for the forced circulation of the fluid contained in the containment body 3 within the containment tank 2.

With reference in particular to the embodiment shown in the figures, the forced circulation means 5 comprise a mixing circuit 6, which has at least one intake duct 7 that can be connected to at least one intake port 7a connected to the containment body 3 and at least one delivery duct 8, which can be connected to at least one delivery port 8a leading into the containment tank 2.

There are also provided means 9 for the forced withdrawal of the fluid contained in the containment body 3 through the intake duct 7 and/or through the intake ports 7a and means (also designated by the reference numeral 9) for conducting the fluid drawn through the intake port or ports 7a toward the delivery port or ports 8a.

Advantageously, the intake duct 7 has, in addition to or instead of the intake port or ports 7a, intake openings 7b which can be associated with adapted partitions that are suitable to generate a Venturi effect in order to facilitate the transfer, to the forced withdrawal means 9, of the parts of calcium chloride that have not yet dissolved and increase significantly the dissolution power by way of the hydraulic and mechanical action generated within the forced withdrawal means 9.

In order to ensure faster solubilization of the calcium chloride in solid form 10 within the water contained in the containment body 3, it is convenient for the delivery ports 8a to lead into the containment body 3 and therefore below the surface of the water in which the calcium chloride in solid form 10 is dissolving.

According to one aspect of the present invention, between the delivery port or ports 8a and the intake port or ports 7a there is provided at least one filter element 12, which is adapted to divide the containment body 3 into an intake chamber 13, which accommodates the intake duct 7, the intake ports 7a and/or the intake openings 7b, and a delivery chamber 14, which accommodates the delivery ports 8a.

Conveniently, the intake chamber 13 is arranged below the delivery chamber 14 so that the calcium chloride in solid form 10 can be discharged through the fill opening 4 into the delivery chamber 14.

The two chambers (the intake chamber 13 and the delivery chamber 14) are mutually connected, since the filter 12 that mutually divides them allows the fluid to flow between them whereas it throttles the access of solid particles from the delivery chamber 14 to the intake chamber 13.

The filter 12, advantageously consisting of a net-like element, prevents, as mentioned, coarse impurities that are present within the calcium chloride in solid form 10 or solid crystals of excessively large size from reaching the vicinity of the intake duct 7 and the intake ports 7a and/or the intake openings 7b, since they would compromise, once they have been aspirated, the correct operation of the forced withdrawal means 9.

Within the containment tank 2, and in particular below the fill opening or openings 4, there is provided a respective distribution body 15 (shaped for example like a pyramid) for distributing the calcium chloride in solid form 10 along the entire containment body 3.

According to a preferred embodiment, the means 9 for forced withdrawal of the fluid from the intake duct 7 and from the intake ports 7a and/or from the intake openings 7b and for conducting the drawn fluid to the delivery ports 8a comprise a pump and, more advantageously, a motorized pump.

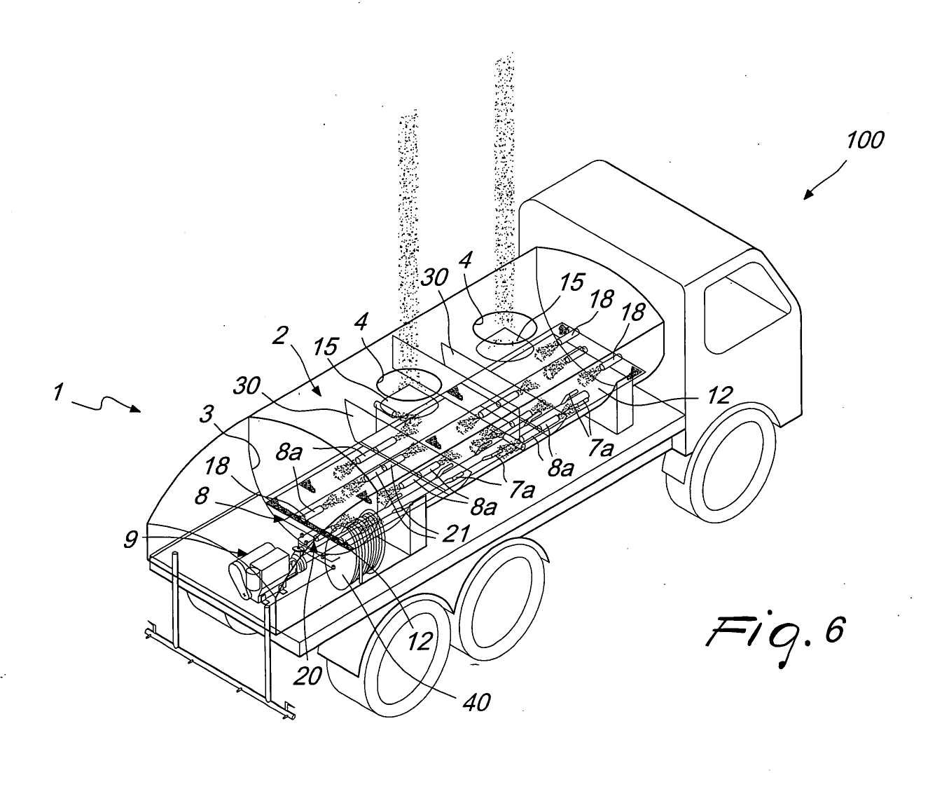

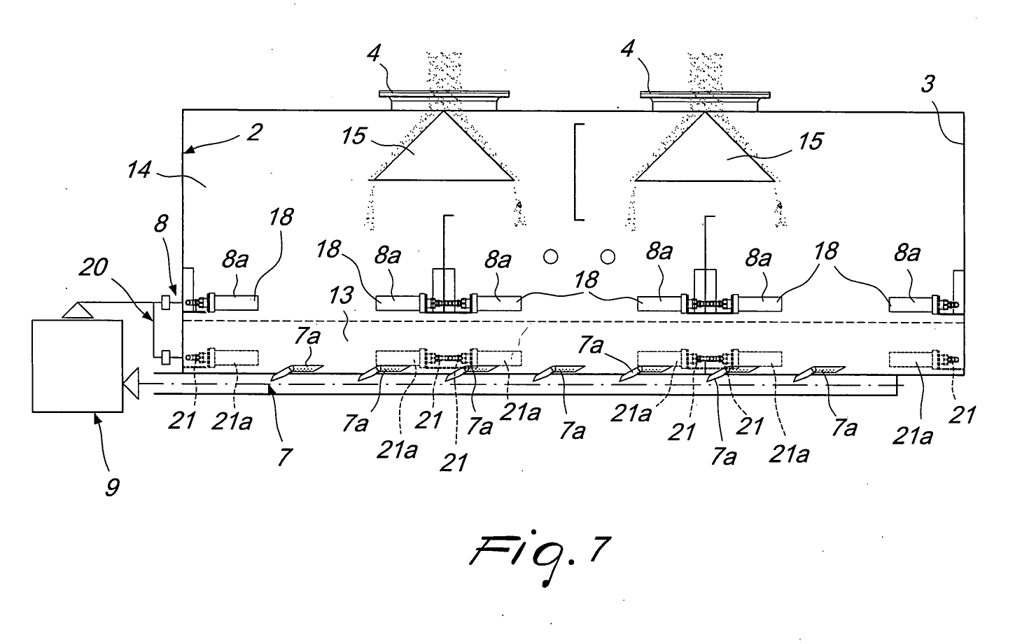

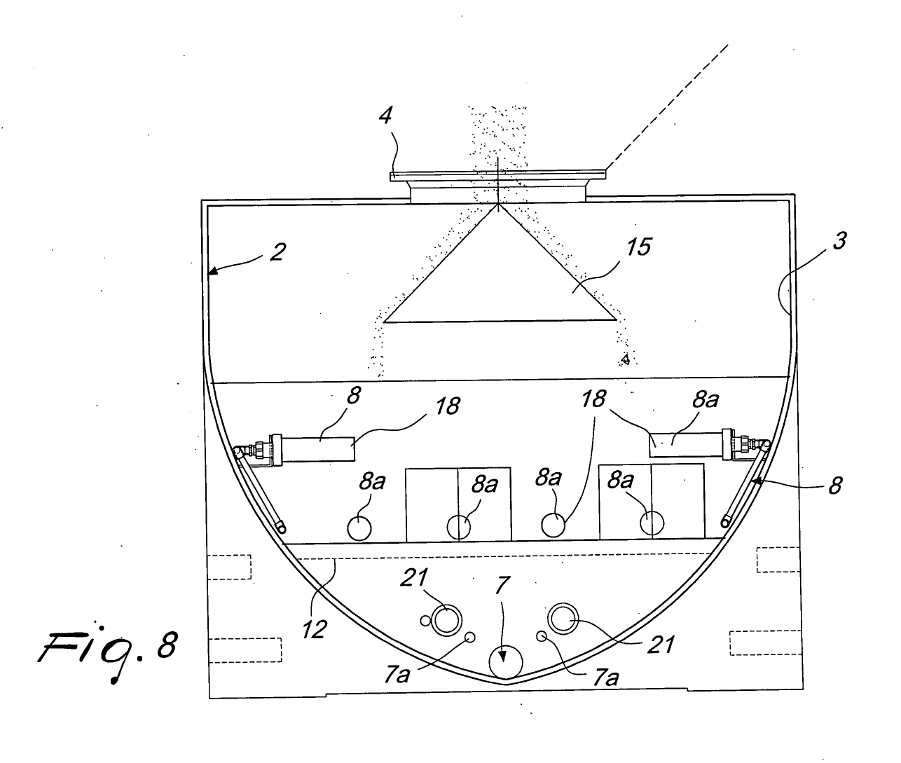

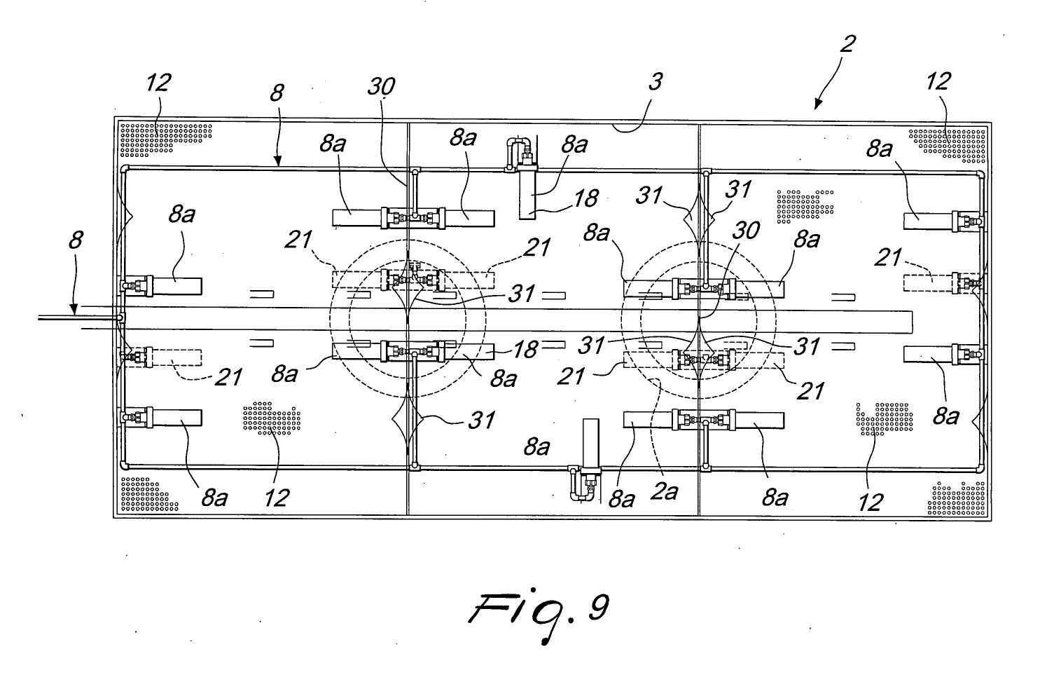

With reference to what is shown in FIGS. 6 to 9, it can be noted that the means 5 for the forced circulation of the fluid contained in the containment body 3 within the containment tank 2 can further comprise a remixing duct 20, which leads into at least one movement nozzle 21 arranged substantially at the bottom of the containment body 3.

As shown, it is advantageous to arrange the movements nozzles 21 below the filter 12 and accordingly inside the intake chamber 13.

It has been found that it is particularly convenient to conduct the solution drawn from the intake duct 7 toward the remixing duct 20 after the solubilization step has been completed, in order to prevent salt residues from depositing on the bottom of the containment tank 2 once the solubilization step has ended.

Advantageously, the containment tank 2 comprises a trailer which is associated with a truck 100.

In practice, in this case, the process for mixing and dissolving the calcium chloride, or in an equivalent manner similar products used as deicers, in solid form 10 can be performed while the truck 100 reaches the location and, by way of the particular mixing means, in extremely short time, so as to allow its use at the maximum generated temperature.

In this regard, the containment tank 2 can be provided so as to thermally insulate its contents: this, by way of example, can be achieved by making the containment tank 2 of fiberglass reinforced plastic or by providing a thermal insulation jacket.

Conveniently, if the containment tank 2 is associated with the trailer of a truck 100, the delivery duct 6 can be provided so that it is connectible, by means of a valve 16 that can be operated on command, to a circuit 17 for distributing and feeding the aqueous solution of calcium chloride to the user device (such as for example one or more spreading nozzles 17a for uniform distribution on the surface to be treated or one or more distribution lances 40).

In order to allow a further reduction of the time needed to dissolve the calcium chloride in solid form 10 in the water contained in the containment body 3, it is advantageous to provide, at the nozzles associated with the delivery ports 8a, respective hydraulic agitators 18, which form internally at least one Venturi tube adapted to ensure, for an equal flow-rate of the nozzle, a movement of the liquid in the vicinity thereof that is even five times or more greater.

This aspect also causes, in addition to an enormous reduction in the time needed to dissolve the salt, a significant reduction in the power of the pump, being able to ensure high mixing even with relatively limited flow-rates thereof.

It has been found that it is particularly advantageous to use hydraulic agitators that form respective Venturi tubes also at the outlets of the movement nozzles 21.

Advantageously, the intake duct 7 and the intake port or ports 7a and/or the intake openings 7b are arranged at the bottom of the containment tank 2.

In order to try to fully exploit the properties of the delivery ports 8a provided with the respective hydraulic agitators 18, it is possible to provide the containment tank 2 with vertical partitions 30, which have, at portions thereof which affect the stream of water that exits from the delivery ports 8a, flow deflectors 31 which are adapted to facilitate forced circulation within the delivery chamber 14; the vertical partitions 30 therefore act as breakwaters.

For this reason also, the delivery ports 8a are arranged so that their axis is parallel to the direction of longitudinal extension of the containment body 3.

At the central region of the containment body 3 it is convenient to provide also for the presence of delivery ports 8a that are arranged so that their axis lies transversely to the direction of longitudinal extension of the containment body 3.

In this regard, there is nothing to forbid the direct provision, on the opposite internal walls of the containment body 3, of additional flow deflectors 31.

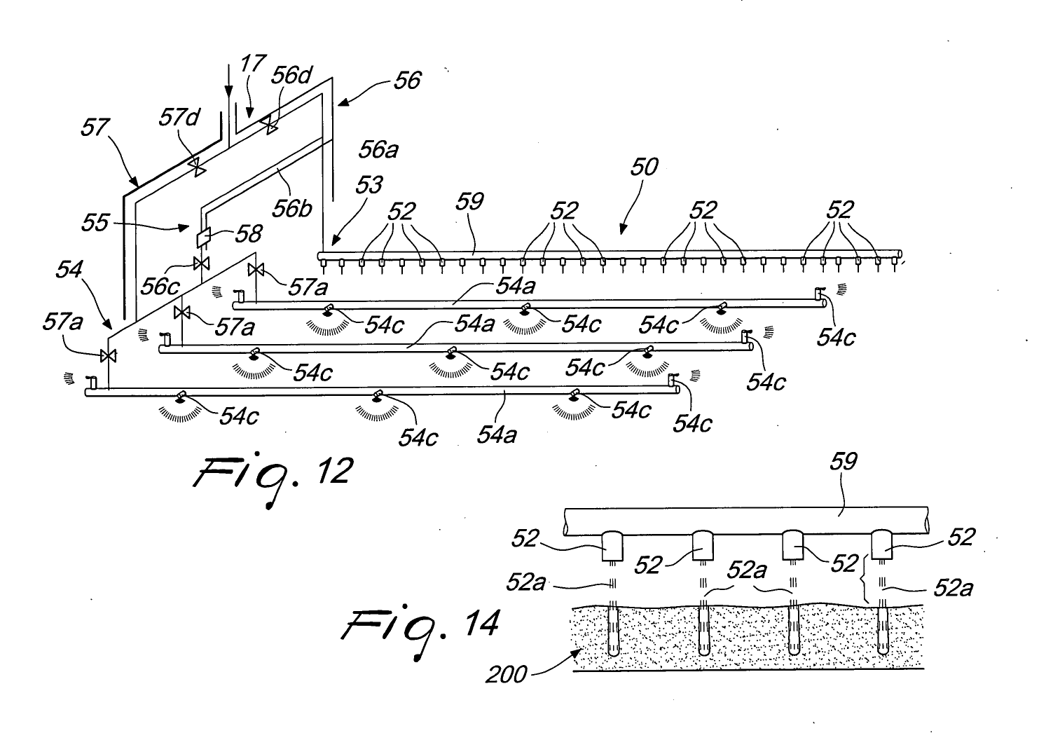

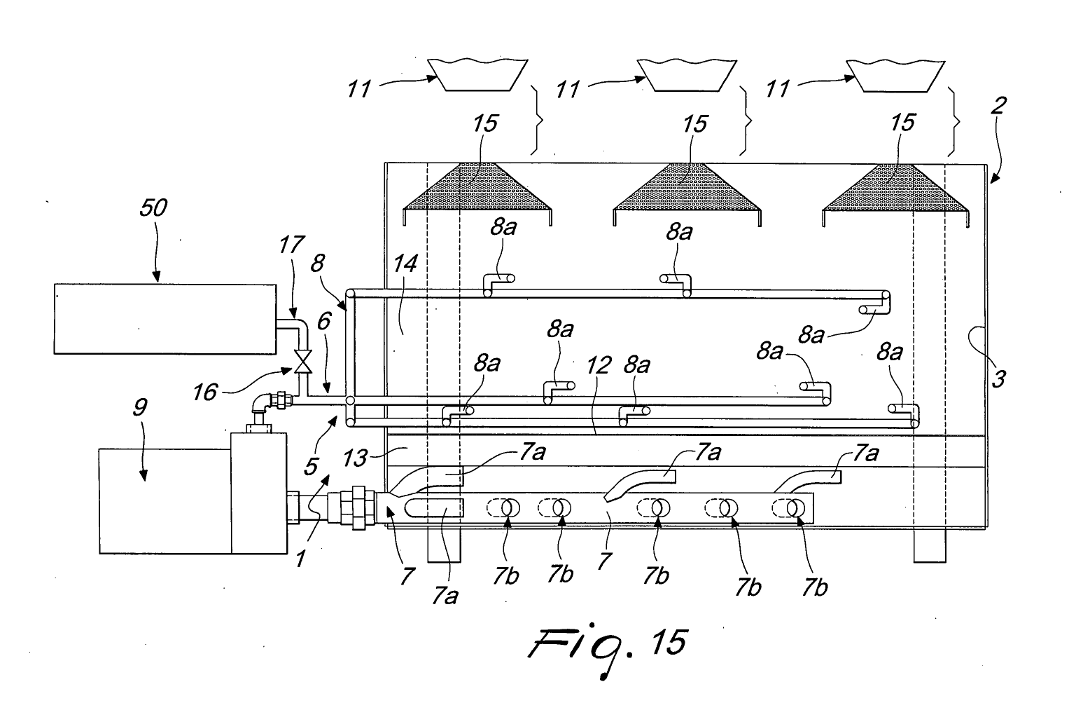

With reference to FIGS. 12 to 15, the present invention relates to a distribution device, generally designated by the reference numeral 50, for spreading, generally on roads, an aqueous solution to be used as a surface deicer, which has a supporting frame 51 that can move on the ground along an advancement direction.

The supporting frame 51 is connected, by means of a distribution and supply circuit 17, to a containment tank 2, which is typically transported by a truck 100.

The supporting frame 51, in particular, is associated with a plurality of straight jet nozzles 52, which are designed to direct, toward the surface onto which the aqueous solution is to be spread, a respective jet 52a designed to strike a substantially point-like region of the ground 200 (typically a layer of snow or ice).

Advantageously, a first distribution body 53 and a second distribution body 54 are mounted on the supporting frame 51; the first distribution body 53 is associated with the plurality of substantially straight jet nozzles 52, and the second distribution body 54 is mounted to the rear with respect to the advancement direction of the supporting frame 51 and comprises at least one diffuser nozzle 54c, which is adapted to dispense a jet of aqueous solution that is distributed at least transversely to the advancement direction of the supporting frame 51.

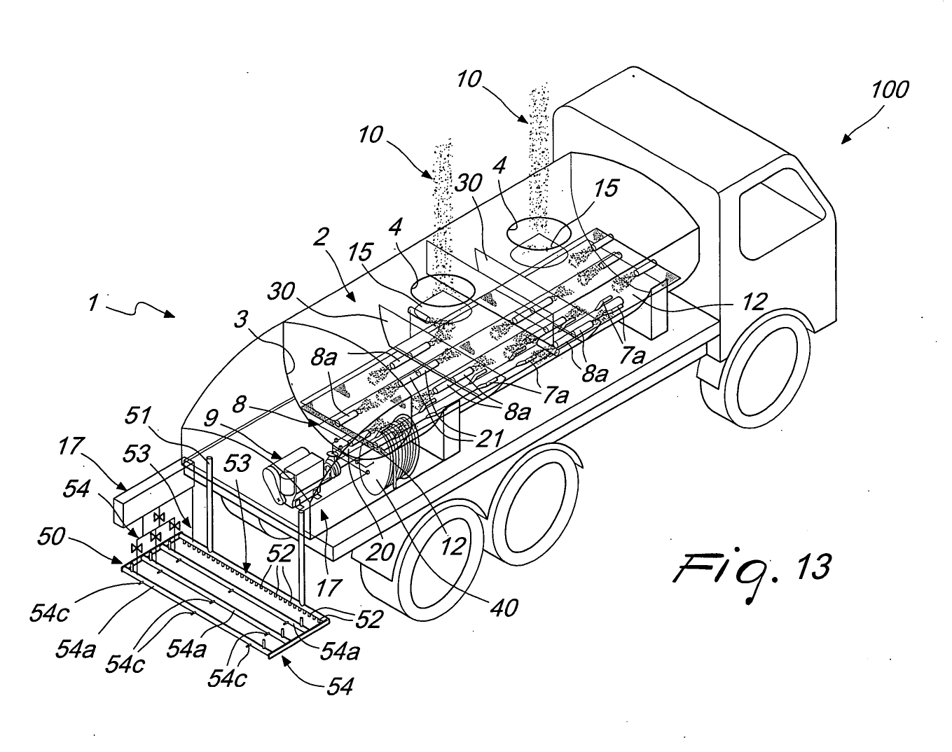

With reference to the practical embodiment shown in FIGS. 12 and 13, the second distribution body 54 consists of multiple distribution bars 54a, on each of which respective diffuser nozzles 54c are fitted which are adapted to dispense a jet of aqueous solution that is diffused in a transverse direction.

Of course, the diffuser nozzles 54c can consist of triangular blade jet nozzles but also of nozzles designed to emit a substantially conical jet.

Advantageously, the distribution and supply circuit 17 comprises means 55 for adjusting the pressure with which the aqueous solution is supplied to the first distribution body 53 and to the second distribution body 54.

It has in fact been found that it is extremely convenient for the jets of aqueous solution 52a that exit from the straight nozzles 52 to have a significantly higher working pressure than the pressure normally used when using classic diffuser nozzles 54c, so as to allow the jets emitted by the straight nozzles 52 to “pierce”, or at least cut into, the layer of snow or ice, allowing the aqueous solution distributed by the second distribution body 54 to penetrate within the layer of snow or ice.

For this reason, the pressure adjustment means 55 are adapted to supply the aqueous solution to the first distribution body 53 at a pressure that is higher than the pressure of the aqueous solution supplied to the second distribution body 54.

In this regard, it has been found that it is particularly effective to arrange for the pressure of the aqueous solution fed to the first distribution body 53 to be particularly high and advantageously specific to the characteristics of the nozzles used (by way of example, the value of said pressure can be comprised between 5 bars and 20 bars, more particularly between 6.5 bars and 15 bars).

It is evident that the action becomes more effective as the pressure increases and accordingly the possibility of using even higher pressures than the ones indicated is not to be excluded.

As regards, on the other hand, the pressure of the aqueous solution supplied to the second distribution body 54, it can be lower and, more in particular, specific to the characteristics of the nozzles used (for example comprised between 2.5 bars and 5 bars).

Conveniently, the distribution and supply circuit 17 comprises a first line 56 for supplying the aqueous solution to the first distribution body 53 and to the second distribution body 54 and a second line 57 for supplying the aqueous solution exclusively to the second distribution body 54.

In this manner, if the road conditions allow, it is possible to feed the aqueous solution to the second line 57, operating the distribution device 50 like a traditional device.

The distribution and supply circuit 17 comprises at least one motorized pump, which is adapted to draw the aqueous solution from the containment tank 2 in order to supply it selectively to the first line 56 or to the second line 57.

According to one practical embodiment, the first line 56 comprises a first delivery portion 56a, which supplies the first distribution body 53, and a second delivery portion 56b, which supplies the second distribution body 54.

It is advantageous to provide, along the second delivery portion 56b, a pressure reduction unit 58 so that when the aqueous solution is supplied both to the first distribution body 53 and to the second distribution body 54 through the first line 56, the pressure can be lower at the second distribution body 54.

It is also convenient to arrange along the second delivery portion 56b, for example downstream of the pressure reduction unit 58, an electric valve 56c, which is adapted on command to interrupt or allow the flow of aqueous solution toward the second distribution assembly 54, so as to prevent the return of the liquid solution “at low pressure” to the first distribution body 53, when only one or more distribution bars 54 must operate.

However, nothing forbids acting on the electric valve 56c to allow, if necessary, supply only to the first distribution assembly 53.

More in particular, as is, among others, shown in the diagram illustrated in FIG. 12, it is convenient to provide additional electric valves 57a upstream of each distribution bar 54a.

Additional electric selection valves 56d and 57d can be arranged substantially at the inlet of the first line 56 and of the second line 57.

In order to adjust appropriately the value of the pressure of the aqueous solution that is fed through the first line 56 to the first distribution body 53 it is possible to act on the rotation rate of the motorized pump.

However, nothing forbids providing the distribution and supply circuit 17 with a supplemental motorized pump that is designed, when operated, to increase the supply pressure of the aqueous solution to the first distribution body 53.

According to one practical embodiment, the first distribution body 53 can consist of at least one sprayer bar 59, which is arranged transversely to the advancement direction of the supporting frame 51.

The sprayer bar 59 supports the plurality of straight nozzles 52 so that they are mutually spaced along their direction of longitudinal extension.

Experimental tests that have been conducted have shown that it is possible to supply the solution both to the first distribution body 53 and to the second distribution body 54 at the same pressure (advantageously, in any case, at a high pressure).

The operation of a device for preparing an aqueous solution of calcium chloride according to the invention is evident from what has been described above.

In particular, the containment body 3 of the containment tank 2 is filled with the necessary amount of water.

If the containment tank 2 constitutes the trailer of a truck 100, it is arranged below the silo 11 that contains the calcium chloride in solid form 10 and the latter is introduced through the fill opening or openings 4 and in the correct quantity (equal to approximately 50% by weight of the quantity of water) into the containment tank 2 and more particularly into the delivery chamber 14.

The pump is then activated and the water (containing the calcium chloride in solid form 10 that is dissolving) is circulated between the intake duct 7 and the intake ports 7a and/or the intake openings 7b and the delivery openings 8a.

In the meantime, one travels toward the location where the solution of water and calcium chloride is to be used, performing in practice the solubilization operations en route, so as to use the solution as soon as the process has ended and therefore also exploiting the high temperature of said solution.

Once the solubilization step has been completed, it is possible to reactivate the pump, optionally intermittently, to supply the solution drawn from the intake duct 7 toward the remixing duct 20 and therefore toward the movement nozzles 21, which remove any deposits.

At an experimental level, it has been found that it is possible to obtain in just five minutes a solution of 10,000 liters of water and calcium chloride.

In particular, if the roadbed to be treated with the deicer solution is particularly challenging for example due to the presence of beds or layers of packed snow, the motorized pump, with the optional aid of the supplemental motorized pump, supplies the aqueous solution, which is cold if the solution prepared previously or stored at room temperature is used, much better if it is still warm (48÷50° C.), with the decisive advantage of triggering immediately the thawing effect if solubilization of the calcium chloride has been performed by using the forced circulation means 5 within the containment tank 2, to the first line 56 and therefore to the first assembly 53 for distribution at high pressure and to the second assembly 54 for distribution at a lower pressure.

The first distribution assembly 53, consisting of the plurality of straight nozzles 52, generates a plurality of concentrated jets 52a of high-pressure aqueous solution, which are directed substantially at right angles to the road so as to bite into, like a rake, the surface of the layer or bed of snow.

The diffuser nozzles 54c carried by the second distribution assembly 54 distribute along the entire roadway additional aqueous solution, which penetrates (or otherwise percolates) within the layer of snow through the incisions provided by the concentrated jets generated by the straight nozzles 52.

In practice, the action of the straight nozzles 52 causes cracks in the snow bed, which allow the solution to act not only superficially but also in the depth of the openings provided in the thickness of said bed, facilitating the massive penetration of the solution that arrives from the successive distribution bars 54a.

It has been found that the aqueous solution, by penetrating below the snow bed, causes its separation from the roadbed, facilitating the intervention of vehicles with snowplow blades and/or the “milling” of the residual layer caused by the rolling of the tires of passing vehicles.

Moreover, it has been observed that especially if the aqueous solution conveyed to the distribution device 50 is warm (a situation which can be established, as mentioned, by using a containment tank 2 provided with the forced circulation means 5), the efficiency and speed of action are increased significantly.

All the characteristics of the invention indicated above as advantageous, convenient or the like may also be omitted or be replaced with equivalents.

The invention thus conceived is susceptible of numerous modifications and variations, all of which are within the scope of the appended claims.

Thus, it is possible to provide for use of the device according to the invention also for dissolving the calcium chloride in solid form 10 in a fixed containment tank 2; in this case, of course, means are provided for transferring the solution onto the trailers normally used by vehicles assigned to deicing treatments of roads.

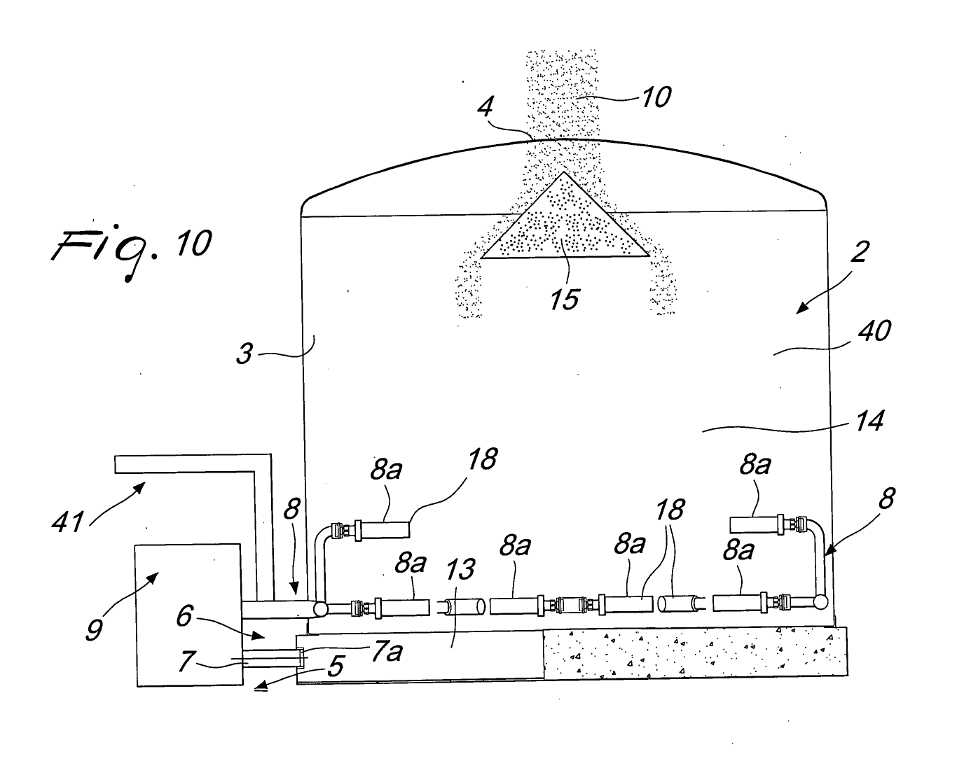

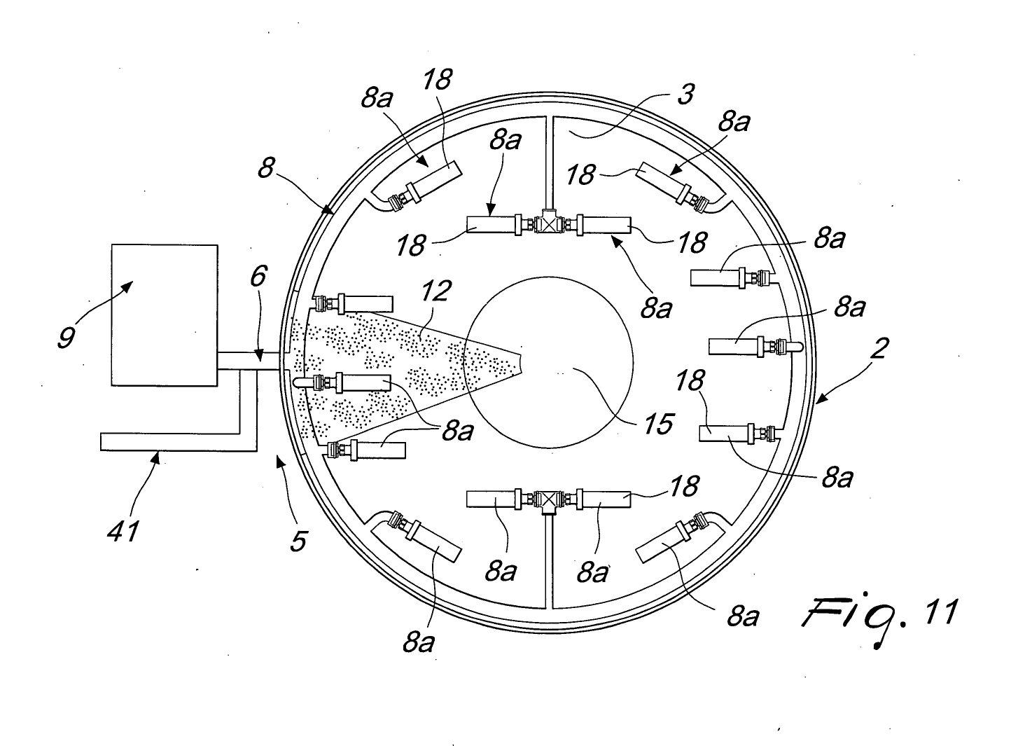

In this regard, FIGS. 10 and 11 illustrate an embodiment of the invention in which the containment tank 2 consists of a fixed containment tank 40 which forms internally a containment body 3 for the water in which the calcium chloride in solid form 10 is to be dissolved.

The fill opening 4 is formed at the top of the fixed containment tank 40.

In this case also, nothing forbids the calcium chloride in solid form 10 from being loaded even manually by means bags or sacks, for example.

In this case also, the mixing means comprise means 5 for the forced circulation of the fluid contained in the containment body 3 within the fixed containment tank 40.

With reference in particular to the embodiment shown in FIGS. 10 and 11, the forced circulation means 5, in this case also, consist of a mixing circuit 6, which has at least one intake duct 7 that can be connected to at least one intake port 7a connected to the containment body 3 and at least one delivery duct 8, which can be connected to at least one delivery port 8a that leads into the containment tank 2.

There are also provided means 9 for forced withdrawal of the fluid contained in the containment body 3 from the intake duct 7 and/or from the intake ports 7a and means (also designated by the reference numeral 9) for supplying the fluid drawn from the intake port or ports 7a toward the delivery port or ports 8a.

Advantageously, the intake duct 7 can be provided, in addition to or instead of the intake port or ports 7a, with intake openings 7b, which can be associated with adapted partitions suitable to produce a Venturi effect, in order to facilitate the transfer of the parts of calcium chloride that have not yet dissolved to the forced withdrawal means 9 and increase significantly the dissolution power by way of the hydraulic and mechanical action generated within the forced withdrawal means 9.

In order to ensure quicker solubilization of the calcium chloride in solid form 10 within the water contained in the containment body 3, it is convenient for the delivery port or ports 8a to lead into the containment body 3 and therefore below the surface of the water in which the calcium chloride in solid form 10 is dissolving.

According to a particularly important aspect of the present invention, between the delivery port or ports 8a and the intake port or ports 7a there is provided at least one filter element 12, which is adapted to divide the containment body 3 into an intake chamber 13, which accommodates the intake duct 7, the intake ports 7a and/or the intake openings 7b, and into a delivery chamber 14, which accommodates the delivery ports 8a.

Conveniently, the intake chamber 13 is arranged below and at a portion of the delivery chamber 14 so that the calcium chloride in solid form 10 can be discharged through the fill opening 4 into the delivery chamber 14.

The two chambers (the intake chamber 13 and the delivery chamber 14) are mutually connected, since the filter 12 that mutually divides them allows the passage of the fluid between them and throttles the access of solid particles from the delivery chamber 14 to the intake chamber 13.

In practice, the intake chamber 13 has an extremely small transverse cross-section with respect to the delivery chamber 14; in this manner, a smaller number of intake ports 7a is needed, whereas mixing within the delivery chamber 14 is ensured by a large number of delivery ports 8a which are arranged conveniently at different heights and are arranged within the delivery chamber 14.

The filter 12, advantageously consisting of a net-like element, prevents, as mentioned, the coarse impurities that are present within the calcium chloride in solid form 10 or solid crystals of excessively large size from reaching the vicinity of the intake duct 7 and of the intake ports 7a and/or of the intake openings 7b, since they would compromise, once they are aspirated, the correct operation of the forced withdrawal means 9.

Inside the containment tank 2, and in particular below the fill opening or openings 4, there is provided a respective distribution body 15 (shaped for example like a pyramid) for distributing the calcium chloride in solid form 10 along the entire containment body 3.

According to a preferred embodiment, the means 9 for forced withdrawal of the fluid from the intake duct 7 and from the intake ports 7a and/or from the intake openings 7b and for feeding the drawn fluid to the delivery ports 8a comprise a pump and, more advantageously, a motorized pump.

It has been found that it is particularly convenient to supply the solution drawn from the intake duct 7 toward a discharge duct 41 (designed to lead into a tank for the transport and distribution of the solution on roads) after the solubilization step has been completed.

In practice it has been found that the invention has achieved the intended aim and objects in all of the embodiments.

In this regard it has been verified that the time needed to dissolve the calcium chloride in solid form 10 is reduced by at least 70% with respect to traditional methods.

Moreover, it has been observed that by way of the use of the hydraulic agitators 18 that use Venturi tubes the power needed to perform solubilization and mixing of the aqueous solution is substantially similar to the power needed to supply a typical distribution circuit.

For this reason, the forced circulation means 5 can be operated by a pump that is sized to serve the distribution and supply circuit 17.

In practice, the dimensions may be any according to requirements.

All the details may further be replaced with other technically equivalent elements.

The disclosures in Italian Patent Applications No. VR2008A000088, VR2008A000143 and VR2009A000022 from which this application claims priority are incorporated herein by reference.

Where technical features mentioned in any claim are followed by reference signs, such reference signs have been inserted for the sole purpose of increasing the intelligibility of the claims and accordingly such reference signs do not have any limiting effect on the interpretation of each element identified by way of example by such reference signs.

1-21. (canceled)

22. A device for preparing an aqueous solution of calcium chloride, particularly for use as a surface deicer, comprising a containment tank which forms a body for containing the water in which said calcium chloride in solid form is to be dissolved and at least one fill opening for said calcium chloride in solid form, said device comprising means for mixing said water with said calcium chloride in solid form in order to obtain a solution of water and calcium chloride, wherein said mixing means comprise means for the forced circulation of the fluid contained in said containment body within said containment tank.

23. The device according to claim 22, wherein said forced circulation means comprise a mixing circuit, which has at least one intake duct which can be connected to at least one intake port connected to said containment body and at least one delivery duct which can be connected to at least one delivery port which leads into said containment tank, means for forced withdrawal of the fluid contained in said containment body from said at least one intake port and means for supplying the drawn fluid toward said at least one delivery port being provided.

24. The device according to claim 22, wherein said means for the forced circulation of the fluid contained in said containment body within said containment tank comprise at least one mixing duct which leads into at least one respective movement nozzle, which is arranged substantially at the bottom of said containment body.

25. The device according to claim 22, where said at least one delivery port leads into said containment body, said at least one delivery port being associated with a respective hydraulic agitator which defines on the inside at least one Venturi tube.

26. The device according to claim 23, wherein said containment tank comprises at least one vertical partition which has, at portions thereof that intercept the stream of water in output from said delivery ports, a respective flow deflector, which is adapted to facilitate forced circulation within said containment body.

27. The device according to claim 23, wherein said containment body has, at its internal surface, at least one flow deflector, which is adapted to intercept the flow of water in output from a respective delivery port in order to facilitate forced circulation within said containment body.

28. The device according to claim 23, wherein between said at least one delivery port and said at least one intake port there is provided at least one filter element that is adapted to divide said containment body into an intake chamber, which accommodates said at least one intake port, and a delivery chamber, which accommodates said at least one delivery port, said calcium chloride in solid form being dischargeable through said at least one fill opening into said delivery chamber.

29. The device according to claim 23 wherein said means for forced withdrawal of the fluid from said at least one intake port and for feeding the drawn fluid to said at least one delivery port comprise a pump.

30. The device according to claim 22, wherein said containment tank comprises a trailer associated with a truck.

31. The device according to claim 24, wherein at least one intake opening and/or said at least one movement nozzle is associated with a respective hydraulic agitator, which defines on the inside at least one Venturi tube.

32. The device according to claim 22, wherein said forced circulation means can be operated by a pump that is sized in order to serve a distribution and supply circuit.

33. The device according to claim 22, wherein said containment tank comprises a fixed containment tank, which defines on the inside said body for containing the water in which the calcium chloride in solid form is to be dissolved.

34. The device according to claim 28, wherein said intake chamber is arranged in a lower region and at a portion of said delivery chamber, the transverse cross-section of said intake chamber being smaller than the cross-section of said delivery chamber.

35. The device according to claim 23, further comprising a discharge duct, which can be connected to said intake duct in order to supply said solution toward a tank for transport and distribution on roads.

36. A device for distributing an aqueous solution for use as a surface deicer, comprising a supporting frame which can move on the ground along an advancement direction and is connected, through a distribution and supply circuit, to a tank for containing said aqueous solution, said supporting frame being associated with a plurality of straight-jet nozzles designed to direct, toward the surface onto which said aqueous solution is to be spread, a respective jet designed to strike a substantially point-like region of the ground.

37. The distribution device according to claim 36, wherein a first distribution body and a second distribution body are mounted on said supporting frame, said first distribution body being associated with said plurality of nozzles with a substantially straight jet, said second distribution body being mounted to the rear with respect to the advancement direction of said supporting frame and comprising at least one diffuser nozzle, which is adapted to dispense a jet of aqueous solution that is distributed at least transversely with respect to said advancement direction.

38. The distribution device according to claim 37, wherein said distribution and supply circuit comprises means for adjusting the pressure at which said aqueous solution is supplied to said first distribution body and to said second distribution body.

39. The distribution device according to claim 38, wherein said pressure adjustment means are adapted to supply said aqueous solution to said first distribution body at a pressure that is higher than the pressure of the aqueous solution fed to said second distribution body.

40. The distribution device according to claim 37, wherein said distribution and supply circuit comprises a first line for supplying said aqueous solution to said first distribution body and to said second distribution body and a second line for supplying said aqueous solution to said second distribution body.

41. The distribution device according to claim 40, wherein said distribution and supply circuit comprises at least one motorized pump that is adapted to draw said aqueous solution from said containment tank to supply it selectively to said first line or to said second line.

42. The distribution device according to claim 37, wherein said first distribution body comprises at least one sprayer bar, which is arranged transversely with respect to the advancement direction of said supporting frame and supports said plurality of straight nozzles so that they are mutually spaced along their direction of longitudinal extension.
